(19) United States
(12) Patent Application Publication
(10) Pub. No.: US 2023/0080446 A1
(43) Pub. Date: Mar. 16, 2023

(54) METHODS, APPARATUS, AND NON-TRANSITORY COMPUTER READABLE MEDIUM FOR AUDIO PROCESSING

(71) Applicant: Alibaba Damo (Hangzhou) Technology Co., Ltd., Hangzhou (CN)

(72) Inventors: Feifei XIONG, Hangzhou (CN); Jinwei FENG, Hangzhou (CN)

(21) Appl. No.: 17/819,196

(22) Filed: Aug. 11, 2022

(30) Foreign Application Priority Data
Aug. 19, 2021 (CN) 202110955730.7

(51) Int. Cl. G10L 21/0232; G10L 25/21; G10L 25/84; G10L 17/06; G10L 25/57; H04M 3/56

(52) U.S. Cl. CPC G10L 21/0232; G10L 17/06; G10L 25/21; G10L 25/57; G10L 25/84; H04M 3/568

(57) ABSTRACT

An audio processing method is provided. The method includes: obtaining to-be-processed audio acquired by an audio acquisition end; performing filtering processing on the to-be-processed audio to obtain a processing result, wherein the filtering processing is used for filtering out partial audio signal components from the to-be-processed audio, and frequencies of the partial audio signal components are lower than a preset threshold; extracting a plurality of speech frames within a first preset duration from the processing result; obtaining an energy variation amount of the plurality of speech frames; and determining a category of the to-be-processed audio based on the energy variation amount.

### CROSS-REFERENCE TO RELATED APPLICATIONS

The disclosure claims the benefits of priority to Chinese Application No. 202110955730.7, filed on Aug. 19, 2021, which is incorporated herein by reference in its entirety.

### TECHNICAL FIELD

The present disclosure relates to audio processing, and more particularly, to methods and systems for audio processing.

### BACKGROUND

With the popularization of audio/video communication systems, various complex acoustic environments are inevitable. In addition, a higher requirement is required on an audio algorithm, to ensure that the audio/video communication systems can maintain high performance in different acoustic environments. In real-time speech communication, an automatic gain control (AGC) module in an audio 3A algorithm is crucial to distinguish between a foreground sound and a background sound. The audio 3A algorithm is an algorithm that adopts an acoustic echo cancellation (AEC) technology, an ambient noise suppression (ANS) technology, and an automatic gain control (AGC) technology simultaneously to ensure fresh and natural speech communication. In some situations, for example, foreground sound is quite small or there is no foreground sound, a voice activity detection (VAD) algorithm cannot distinguish between the foreground sound and the background sound, such that the AGC module may improve a volume of the background sound by mistake. As a result, a remote user hears a louder background sound, which greatly affects the user experience. A background speech scenario generally occurs especially in an open conference room.

Currently, many solutions used to distinguish between the foreground sound and the background sound are based on a training model. However, such solutions have a large calculation amount and cannot work in real time, and the distinguishing accuracy is not qualitatively improved.

### SUMMARY OF THE DISCLOSURE

Embodiments of the present disclosure provide an audio processing method. The method includes: obtaining to-be-processed audio acquired by an audio acquisition end; performing filtering processing on the to-be-processed audio to obtain a processing result, wherein the filtering processing is used for filtering out partial audio signal components from the to-be-processed audio, and frequencies of the partial audio signal components are lower than a preset threshold; extracting a plurality of speech frames within a first preset duration from the processing result; obtaining an energy variation amount of the plurality of speech frames; and determining a category of the to-be-processed audio based on the energy variation amount.

Embodiments of the present disclosure also provide an apparatus for performing audio processing. the apparatus includes a memory figured to store instructions; and one or more processors configured to execute the instructions to cause the apparatus to perform: obtaining to-be-processed audio acquired by an audio acquisition end; performing filtering processing on the to-be-processed audio to obtain a processing result, wherein the filtering processing is used for filtering out partial audio signal components from the to-be-processed audio, and frequencies of the partial audio signal components are lower than a preset threshold; extracting a plurality of speech frames within a first preset duration from the processing result; obtaining an energy variation amount of the plurality of speech frames; and determining a category of the to-be-processed audio based on the energy variation amount.

Embodiments of the present disclosure also provide a non-transitory computer readable medium that stores a set of instructions. The set of instructions that is executable by one or more processors of an apparatus to cause the apparatus to perform: obtaining to-be-processed audio acquired by an audio acquisition end; performing filtering processing on the to-be-processed audio to obtain a processing result, wherein the filtering processing is used for filtering out partial audio signal components from the to-be-processed audio, and frequencies of the partial audio signal components are lower than a preset threshold; extracting a plurality of speech frames within a first preset duration from the processing result; obtaining an energy variation amount of the plurality of speech frames; and determining a category of the to-be-processed audio based on the energy variation amount.

It should be understood that the above general description and the following detailed description are only exemplary and explanatory, and do not limit the embodiments of the present disclosure.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is an exemplary structural block diagram of a hardware of a computer terminal (or a mobile device) configured to implement an audio processing method, according to some embodiments of the present disclosure.

FIG. 2 is a flowchart of an exemplary audio processing method, according to some embodiments of the present disclosure.

FIGS. 3A-3B are schematic diagrams of a frequency response curve of an exemplary high-pass filter, according to some embodiments of the present disclosure.

FIGS. 4A-4B are schematic diagrams of an exemplary amplitude distribution of a foreground sound and a background sound, according to some embodiments of the present disclosure.

FIG. 5 is a flowchart of another exemplary audio processing method, according to some embodiments of the present disclosure.

FIG. 6 is a flowchart of another exemplary audio processing method, according to some embodiments of the present disclosure.

FIG. 7 is a flowchart of another exemplary audio processing method, according to some embodiments of the present disclosure.

FIG. 8 is a schematic structural diagram of an exemplary audio processing device, according to some embodiments of the present disclosure.

FIG. 9 is a structural block diagram of an exemplary computer terminal, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

It should be noted that the terms “include,” “comprise,” or any other variations thereof are intended to cover non-exclusive inclusion, so that a commodity or system including a series of elements not only includes the elements, but also includes other elements not explicitly listed, or further includes elements inherent to the commodity or system. In the absence of more limitations, an element defined by “including a/an ... ” does not exclude that the commodity or system including the element further has other identical elements.

It should also be noted that provided that there is no conflict, the embodiments in the present disclosure and the features in the embodiments can be combined with each other. The embodiments of the present disclosure will be described in detail below with reference to the drawings and in conjunction with the embodiments.

As stated above, conventional audio/video communication systems cannot work in real time due to the large number of calculations and processing times. According to the embodiments of the present disclosure, even in a case that a foreground sound is quite small or in a case that there is no foreground sound, after the processing result is obtained by performing filtering processing on the to-be-processed audio acquired by an audio acquisition end, a plurality of speech frames within a first preset duration are extracted from the processing result, an energy variation amount of the plurality of speech frames are obtained, and a category of the to-be-processed audio can be further determined based on the energy variation amount. Therefore, whether the to-be-processed audio is a foreground sound or a background sound can be distinguished. In a remote audio/video scenario, a louder background sound cannot be heard by a remote user, so that the user experience is improved.

The objective of quickly and accurately distinguishing between a foreground sound and a background sound is achieved, thereby improving the audio distinguishing efficiency and the user experience, and further resolving the technical problems of low audio distinguishing efficiency and poor user experience caused by that the audio system cannot distinguish between a foreground sound and a background sound.

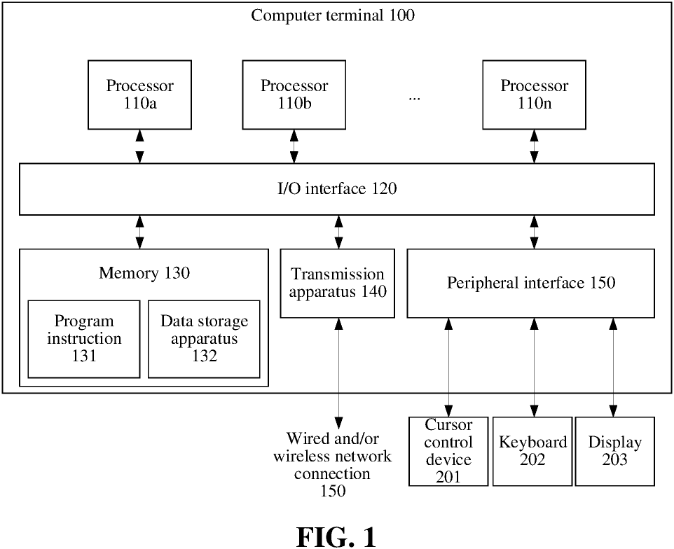

In some embodiments, the proposed method may be executed in a mobile terminal, a computer terminal, or a similar computing apparatus. FIG. 1 is a structural block diagram of a hardware of a computer terminal 100 (or a mobile device) configured to implement an audio processing method. As shown in FIG. 1, a computer terminal 100 (or a mobile device) may include one or more processors 110 (shown as 110a, 110b, ..., and 110n in FIG. 1), a memory 130 configured to store data, and a transmission apparatus 140 for a communication function. The processor 110 may include, but is not limited to, a processing apparatus, for example, a microprocessor (MCU) or a programmable logic device (FPGA). In addition, the computer terminal 100 (or the mobile device) may further include, an input/output interface (I/O interface) 120, a peripheral interface 150, a universal serial bus (USB) port (may be included as one of ports of the bus), a network interface, a power supply, and/or a camera. A person of ordinary skill in the art may understand that the structure shown in FIG. 1 is only for the purpose of illustration, and does not constitute a limitation to the structure of the electronic device. For example, the computer terminal 100 may also include more or fewer components than those shown in FIG. 1, or have a configuration different from that shown in FIG. 1.

It should be noted that the foregoing one or more processors 110 and/or other data processing circuits in this specification may be generally referred to as a “data processing circuit.” The data processing circuit may be entirely or partly embodied as software, hardware, firmware, or any combination thereof. In addition, the data processing circuit may be an independent processing module, or may be combined into any of other elements in the computer terminal 100 (or the mobile device) entirely or partly. As mentioned in the embodiments of the disclosure, the data processing circuit is used as a processor control (for example, a selection of a variable resistance terminal path connected to an interface).

Memory 130 may be configured to store a software program and a module of application software, such as a program instruction 131/data storage apparatus 132 corresponding to the audio processing method in the embodiments of this disclosure. Processor 110 runs the software program and the module stored in memory 130, so as to execute various functional applications and data processing, that is, implement the foregoing audio processing method of an application program. Memory 130 may include a high-speed random memory, and a non-volatile memory such as one or more magnetic storage apparatuses, a flash memory, or another non-volatile solid-state memory. In some examples, memory 130 may further include memories remotely arranged relative to processor 110, and these remote memories may be connected to computer terminal 100 through a network. Examples of the network include, but are not limited to, the Internet, an intranet, a local area network, a mobile communication network, and a combination thereof.

Transmission apparatus 140 is configured to receive or send data through a network, for example a wired and/or wireless network connection 150. A specific example of the foregoing network may include a wireless network provided by a communication provider of computer terminal 100. In some embodiments, transmission apparatus 140 includes a network interface controller (NIC), which may be connected to another network device through a base station so as to communicate with the Internet. In some embodiments, transmission apparatus 140 may be a radio frequency (RF) module, which is configured to communicate with the Internet in a wireless manner.

On or more peripheral devices can be coupled to computer terminal 100 via peripheral interface 150. For example, the one or more peripheral devices includes a cursor control device 201, a keyboard 202, and/or a display 203. Display 203 may be a touch screen type liquid crystal display (LCD), and the LCD enables the user to interact with a user interface of computer terminal 100 (or the mobile device).

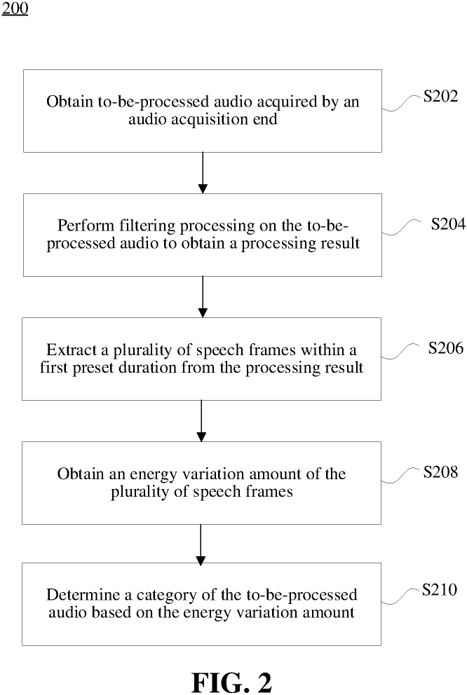

In the foregoing operating environment, the present disclosure provides an audio processing method. FIG. 2 is a flowchart of an exemplary audio processing method 200 according to an embodiment of the present disclosure. As shown in FIG. 2, the method 200 includes steps S202 to S210.

At step S202, to-be-processed audio is acquired by an audio acquisition end. In some embodiments, the audio acquisition end is an acquisition end of a speech communication device, for example, a microphone device. The microphone device can be applicable to or arranged in an audio/video product. During use of the audio/video product, audio processing can be performed on the to-be-processed audio acquired by the microphone device according to an actual situation, to determine a category of the to-be-processed audio. The audio/video product can be a video conference system, an on-line class system or any other audio/video communication system.

At step S204, a filtering processing on the to-be-processed audio is performed to obtain a processing result. The filtering processing is used for filtering out partial audio signal components from the to-be-processed audio. Frequencies of the partial audio signal components are lower than a preset threshold. In some embodiments, the filtering processing can be in a band-pass filtering processing manner or a high-pass filtering processing manner. Taken the high-pass filtering processing manner for example, high-pass filtering processing may be performed on the to-be-processed audio by a high-pass filter, to filter out partial audio signal components from the to-be-processed audio, and frequencies of the partial audio signal components are lower than a preset threshold. The high-pass filter suppresses energy of low-frequency signals while allowing high-frequency signals to pass through design of the filter. For example, a range of a preset threshold corresponding to high-pass filtering processing may be 4 kHZ or higher. Compared with an effect of band-pass filtering processing, an effect of filtering processing within this range (e.g., equal to or greater than 4 kHZ) is better, where a preset threshold corresponding to a band-pass filtering processing with a range from 3 kHZ to 8 kHZ.

The processing result is obtained after the partial audio signal components are filtered out from the to-be-processed audio. In some embodiments, the high-pass filter is also referred to as a high-frequency filter, for example, a non-recursive filter or a finite impulse response (FIR) filter. A purpose for filtering processing is to obtain energy of high-frequency signals in the to-be-processed audio. That is, energy of low-frequency signals is suppressed while the high-frequency signals of the to-be-processed audio are allowed to pass based on a design of the high-pass filter. Therefore, a foreground sound and a background sound can be further distinguished according to high-frequency energy changes.

At step S206, a plurality of speech frames within a first preset duration are extracted from the processing result. In some embodiments, the first preset duration is a preset time period (e.g., 3 seconds), which is not limited in the embodiments of the present disclosure. In practice, the first preset duration can be set and changed according to an actual requirement. In some embodiments, a plurality of speech frames within the first preset duration may be extracted from the processing result in a VAD manner. A VAD is also referred to as voice endpoint detection or voice boundary detection. An objective of the VAD is to recognize and eliminate a long silent period from an audio signal flow, to save voice channel resources without degrading quality of service, and therefore may be applicable to distinguish between a voice and a non-voice.

At step S208, an energy variation amount of the plurality of speech frames are obtained. In some embodiments, the energy variation amount of the plurality of speech frames includes an energy mean value and an energy variance value of a plurality of energy values.

At step S210, a category of the to-be-processed audio is determined based on the energy variation amount. In some embodiments, the category of the to-be-processed audio includes: a foreground sound and a background sound. Taken the audio processing method a remote video conference scenario in which the audio processing method is used for example, based on high-frequency performance of a foreground sound (for example, a voice of a host) and a background sound on the acquisition end of the speech communication device, the foreground sound and the background sound in the to-be-processed audio are automatically distinguished through the high-pass filter. That is, according to the propagation principle of speech signals, high-frequency signals are close to linear propagation and can hardly bypass an obstacle, so that characteristics of high-frequency signals passing through the high-pass filter can be used for determining whether an acquired speech signal is a background sound.

According to the embodiments of the present disclosure, even in a case that a foreground sound is quite small or in a case that there is no foreground sound, after the processing result is obtained by performing filtering processing on the to-be-processed audio acquired by an audio acquisition end, a plurality of speech frames within a first preset duration are extracted from the processing result, an energy variation amount of the plurality of speech frames are obtained, and a category of the to-be-processed audio can be further determined based on the energy variation amount. Therefore, whether the to-be-processed audio is a foreground sound or a background sound can be distinguished. In a remote audio/video scenario, a louder background sound cannot be heard by a remote user, so that the user experience is improved.

The objective of quickly and accurately distinguishing between a foreground sound and a background sound is achieved, thereby improving the audio distinguishing efficiency and the user experience, and further resolving the technical problems of low audio distinguishing efficiency and poor user experience caused by that the audio system cannot distinguish between a foreground sound and a background sound.

In some embodiments, the audio processing method provided in the present disclosure may be applicable to, but not limited to, an audio/video real-time communication project (for example, a remote video conference), an audio/video product (for example, an audio/video communication system or a conference audio device), or an audio/video delivery class. By applying the audio processing method provided, an audio acquired by microphone devices built in different audio/video devices may be automatically processed.

The audio processing methods provided by the present disclosure have a high technology integration degree with an existing AGC technology, and the calculation amount is small. AGC is a module that automatically increases or decreases a volume of input audio according to an estimated volume of the input audio and a difference between the estimated volume and a set volume. It has been proved through tests that the audio processing methods has strong compatibility with an audio/video device. In a product implementation process, the audio process methods may be applicable to, but not limited to, scenarios such as an audio/video delivery class, audio/video, and ecosystems thereof.

In some embodiments, step S204 that performing filtering processing on the to-be-processed audio to obtain a processing result further includes: performing high-pass filtering processing on the to-be-processed audio through an FIR filter to obtain the processing result, where a filter order of the FIR filter is a positive integer greater than or equal to 1.

In this example, high-pass filtering processing can be performed on the to-be-processed audio through an FIR filter to obtain the processing result.

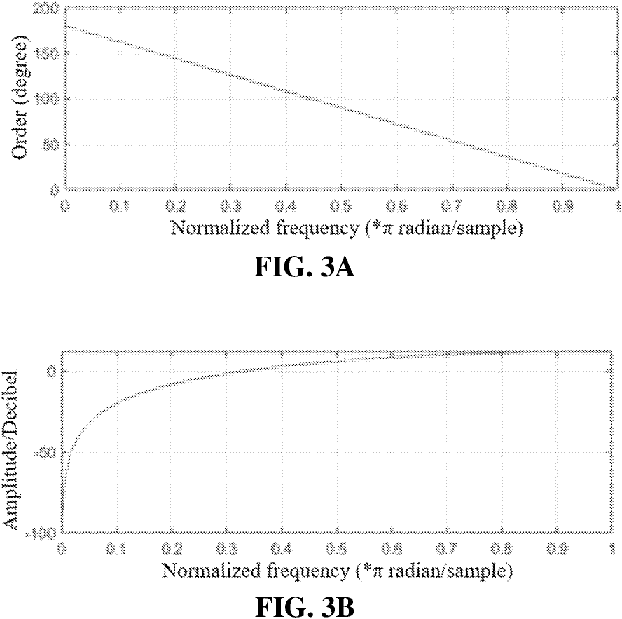

In some embodiments, the filter order of the FIR filter is n (n is generally a positive integer greater than or equal to 1), and a higher order of n indicates greater suppression on low-frequency signals. FIG. 3A is a schematic diagram showing a relationship between a filter number and suppression on low-frequency signals. Referring to FIG. 3A, a higher order of n corresponds to a greater suppression on low-frequency signals. FIG. 3B is a schematic diagram of a frequency response curve of an exemplary high-pass filter, according to some embodiments of the present disclosure. Referring to FIG. 3B, the order n is assumed to 2, and a frequency response curve of the high-pass filter is shown.

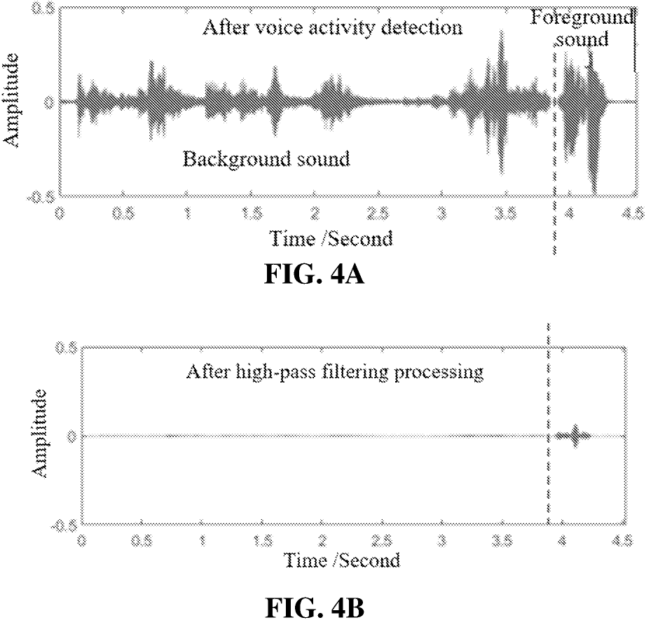

FIGS. 4A and 4B show an exemplary amplitude distribution of a foreground sound and a background sound before and after high-pass filter processing performed respectively, according to some embodiments of the present disclosure. FIG. 4A shows an amplitude distribution of the foreground sound and the background sound after VAD performed on the to-be-processed audio, and before the high-pass filtering processing being performed on the to-be-processed audio. FIG. 4B shows an amplitude distribution of the foreground sound and the background sound after the high-pass filtering processing is performed on the to-be-processed audio. As shown in FIG. 4B, the background sound is suppressed, while the foreground sound is kept.

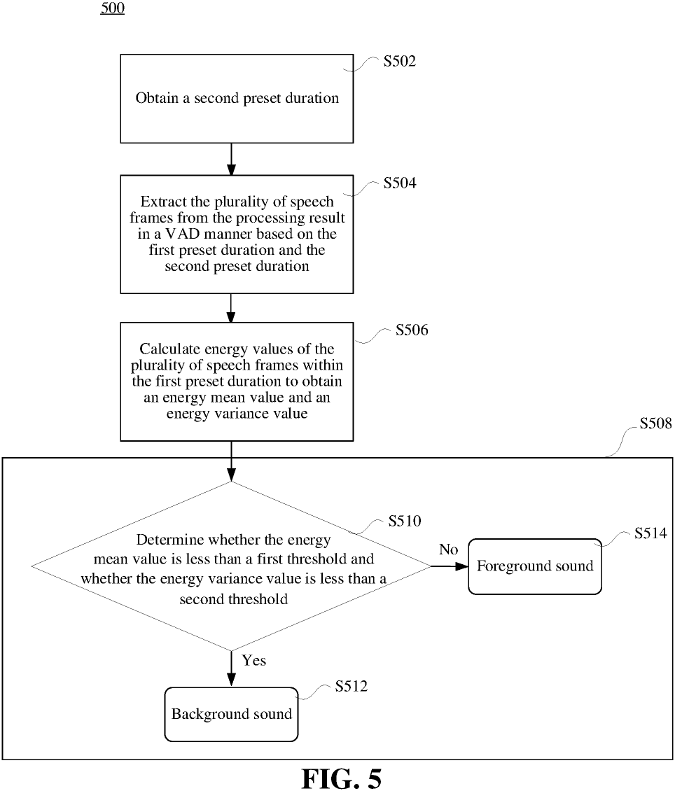

FIG. 5 is a flowchart of another exemplary audio processing method 500, according to some embodiments of the present disclosure. It is appreciated that step S206 of FIG. 2 for extracting a plurality of speech frames within a first preset duration from the processing result can further include step S502 and S504.

At step S502, a second preset duration is obtained. In some embodiments, the obtained second preset duration is a unit duration corresponding to each speech frame in the plurality of speech frames. The second preset duration is a preset time period less than the first preset duration, for example, 10 milliseconds, which is not limited herein. In practice, the second preset duration can be set and changed according to an actual requirement.

At step S504, the plurality of speech frames are extracted from the processing result in a VAD manner based on the first preset duration and the second preset duration.

In some embodiments, high-pass filtering processing is performed by inputting the to-be-processed audio acquired by the audio acquisition end into the high-pass filter to obtain the processing result. Signal processing (e.g., noise removing) is performed on the plurality of speech frames (e.g., each frame may be 10 ms) of a second preset duration within the first preset duration (e.g., 3 s) through a VAD module, to further extract the plurality of speech frames from the processing result.

In some embodiments, step S208 of FIG. 2 for obtaining an energy variation amount of the plurality of speech frames may further includes following steps: obtaining an energy value corresponding to each speech frame in the plurality of speech frames, and a plurality of energy values are obtained; and calculating an energy mean value and an energy variance value of the plurality of energy values.

Referring back to FIGS. 4A and 4B, because a volume of the background speech basically reaches a volume of a host (foreground speech), all sounds detected through VAD are voices (as shown in FIG. 4A). It can be clearly seen that audio signals of the voice of the host have greater energy and a larger variance value after high-frequency filtering (as shown in FIG. 4B). Referring to FIG. 3B, if a sampling rate is 48 kHZ, the sampling rate at 0.2 (i.e., at X-axis) corresponds to 4800 Hz (48 k/2*0.2 Hz), and there is an attenuation of -8 dB (i.e., at Y-axis). The attenuation is larger in a low-frequency range (less than 4800 Hz), that is, low-frequency energy is suppressed and high-frequency energy is maintained.

In some embodiments, referring back to FIG. 5, the method 500 further includes step S506 and S508.

At step S506, energy counting is performed on each speech frame in the plurality of speech frames within the first preset duration to obtain an energy variation amount. The energy variation amount includes an energy mean value and an energy variance value.

At step S508, a first threshold Thres1 of the energy mean value and a second threshold Thres2 of the variance value are set to determine the category of the to-be-processed audio, namely, to determine whether a current state enters a background speech state.

In some embodiments, step S508 that determining a category of the to-be-processed audio based on the energy variation amount further includes: determining the category of the to-be-processed audio based on a comparison result between the energy mean value and the first threshold and a comparison result between the energy variance value and the second threshold. In some embodiments, step S508 that determining a category of the to-be-processed audio based on a comparison result between the energy mean value and the first threshold and a comparison result between the energy variance value and the second threshold includes: determining the to-be-processed audio as a background sound in a case that the energy mean value is less than the first threshold and the energy variance value is less than the second threshold. In some embodiments, step S508 that determining a category of the to-be-processed audio based on a comparison result between the energy mean value and the first threshold and a comparison result between the energy variance value and the second threshold includes: determining the to-be-processed audio as a foreground sound in a case that the energy mean value is greater than or equal to the first threshold and the energy variance value is greater than or equal to the second threshold.

Referring to FIG. 5, in some embodiments, step S508 that determining a category of the to-be-processed audio based on a comparison result between the energy mean value and the first threshold and a comparison result between the energy variance value and the second threshold includes step S510 to S514.

At step S510, whether the energy mean value is less than a first threshold and whether the energy variance value is less than a second threshold are determined.

At step S512, the to-be-processed audio is determined as a background sound when the energy mean value is less than the first threshold and the energy variance value is less than the second threshold.

At step S514, the to-be-processed audio is determined as a foreground sound when the energy mean value is greater than or equal to the first threshold and the energy variance value is greater than or equal to the second threshold.

According to the embodiments of the present disclosure, actual application scenarios may be fully utilized to extract feature values for distinguishing between a host/background speech, thereby achieving the objective of quickly and accurately distinguishing between a foreground sound and a background sound. In addition, the calculation amount is small and is easy to implement, thereby achieving the technical effects of improving the audio distinguishing efficiency and improving the user experience.

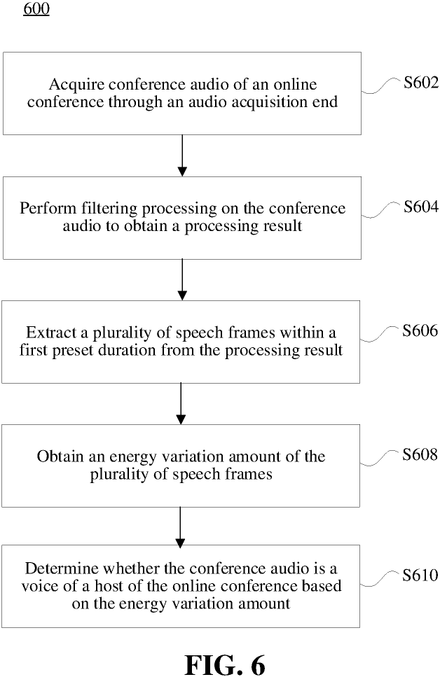

In some embodiments, the present disclosure provides another audio processing method. FIG. 6 is a flowchart of another audio processing method 600, according to some embodiment of the present disclosure. As shown in FIG. 6, the audio processing method includes steps S602 to S610.

At step S602, a conference audio of an online conference is acquired through an audio acquisition end. In some embodiments, the audio acquisition end is an acquisition end of a speech communication device, for example, a microphone device. The microphone device can be applicable to or arranged in an audio/video product. During use of the audio/video product, audio processing may be performed on conference audio acquired by the microphone device according to an actual situation, to determine a category of the conference audio.

At step S604, filtering processing is performed on the conference audio to obtain a processing result. The filtering processing is used for filtering out partial audio signal components from the conference audio, and frequencies of the partial audio signal components are lower than a preset threshold. In some embodiments, the filtering processing may be in a band-pass filtering processing manner or a high-pass filtering processing manner. Taken the high-pass filtering processing manner for example, high-pass filtering processing can be performed on the conference audio through a high-pass filter, to filter out partial audio signal components from the conference audio, and frequencies of the partial audio signal components are lower than a preset threshold. A range of a preset threshold corresponding to high-pass filtering processing may be 4 kHZ or higher. Compared with an effect of band-pass filtering processing, an effect of filtering processing within this range (e.g., equal to or greater than 4 kHZ) is better, where a preset threshold corresponding to a band-pass filtering processing with a range from 3 kHZ to 8 kHZ.

The processing result is obtained after the audio signal components are filtered out from the conference audio. In some embodiments, the high-pass filter is also referred to as a high-frequency filter, for example, a non-recursive filter or a finite impulse response (FIR) filter. A purpose of filtering processing is to obtain energy of high-frequency signals in the conference audio. That is, energy of low-frequency signals is suppressed while the high-frequency signals of the conference audio are allowed to pass based on a design of the high-pass filter. Therefore, a foreground sound and a background sound can be further distinguished according to high-frequency energy changes.

At step S606, a plurality of speech frames within a first preset duration are extracted from the processing result.

In some embodiments, the first preset duration is a preset time period, for example, 3 seconds, which is not limited herein. In practice, the first preset duration can be set and changed according to an actual requirement of a user.

In some embodiments, a plurality of speech frames within the first preset duration may be extracted from the processing result in a VAD manner.

At step S608, an energy variation amount of the plurality of speech frames is obtained. In some embodiments, the energy variation amount of the plurality of speech frames includes an energy mean value and an energy variance value of a plurality of energy values.

At step S610, whether the conference audio is a voice of a host of the online conference is determined based on the energy variation amount. In some embodiments, the category of the conference audio includes: a foreground sound and a background sound. Taken the audio processing method a remote video conference scenario in which the audio processing method is used for example, based on high-frequency performance of a foreground sound (for example, a voice of a host) and a background sound on the acquisition end of the speech communication device, the foreground sound and the background sound in the conference audio are automatically distinguished. That is, according to the propagation principle of speech signals, high-frequency signals are close to linear propagation and can hardly bypass an obstacle, so that characteristics of high-frequency signals passing through the high-pass filter can be used for determining whether an acquired speech signal is a background sound.

In some embodiments, the audio processing method provided in the embodiments of the present disclosure may be applicable to, but not limited to, a remote conference application scenario, for example, an audio/video real-time communication project (for example, a remote video conference). By applying the audio processing method provided in the present disclosure, audio acquired by microphone devices of different audio/video devices can be automatically processed in the remote conference application scenario.

According to the embodiments of the present disclosure, even in a case that a foreground sound (that is, a voice of a host of an online conference) is quite small or in a case without the foreground sound, after a processing result is obtained by performing filtering processing on conference audio acquired by an audio acquisition end, a plurality of speech frames within a first preset duration are extracted from the processing result, an energy variation amount of the plurality of speech frames are obtained, and a category of the conference audio may be further determined based on the energy variation amount. That is, whether the conference audio is a foreground sound or a background sound can be distinguished. Therefore, in a remote audio/video scenario, a remote user may not hear a louder background sound, so that the user experience may not be affected.

With this method, the objective of quickly and accurately distinguishing between a foreground sound and a background sound is achieved, thereby achieving technical effects of improving the audio distinguishing efficiency and improving the user experience, and further resolving the technical problems of low audio distinguishing efficiency and poor user experience caused by that the audio system cannot distinguish between a foreground sound and a background sound in the related art.

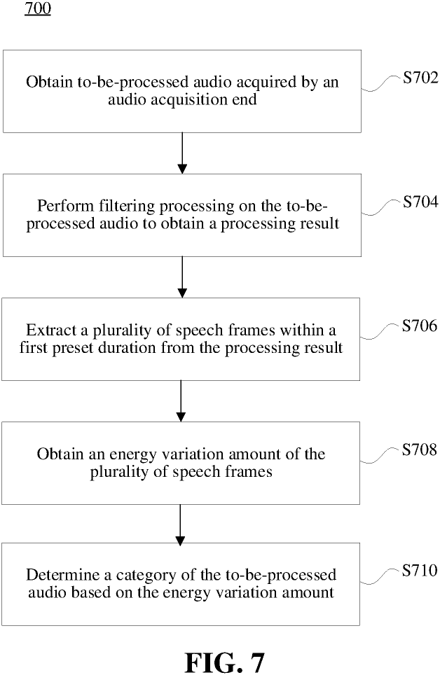

In some embodiments, the present disclosure further provides another audio processing method. FIG. 7 is a flowchart of another audio processing method 700 according to some embodiments of the present disclosure. As shown in FIG. 7, audio processing method 700 includes steps S702 to S710.

At step S702, a teaching audio of an online class is acquired through an audio acquisition end. In some embodiments, the audio acquisition end is an acquisition end of a speech communication device, for example, a microphone device. The microphone device can be applicable to or arranged in an audio/video product, and during use of the audio/video product, audio processing can be performed on a teaching audio acquired by the microphone device according to an actual situation, to determine a category of the teaching audio.

At step S704, filtering processing is performed on the teaching audio to obtain a processing result. The filtering processing is used for filtering out partial audio signal components from the teaching audio, and frequencies of the partial audio signal components are lower than a preset threshold. In some embodiments, the filtering processing may be in a band-pass filtering processing manner or a high-pass filtering processing manner. Taken the high-pass filtering processing manner for example, high-pass filtering processing may be performed on the to-be-processed audio by a high-pass filter, to filter out partial audio signal components from the to-be-processed audio, and frequencies of the partial audio signal components are lower than a preset threshold. The high-pass filter suppresses energy of low-frequency signals while allowing high-frequency signals to pass through design of the filter. For example, a range of a preset threshold corresponding to high-pass filtering processing may be 4 kHZ or higher. Compared with an effect of band-pass filtering processing, an effect of filtering processing within this range (e.g., equal to or greater than 4 kHZ) is better, where a preset threshold corresponding to a band-pass filtering processing with a range from 3 kHZ to 8 kHZ.

The processing result is obtained after the audio signal components are filtered out from the teaching audio. In some embodiments, the high-pass filter is also referred to as a high-frequency filter, for example, a non-recursive filter or a finite impulse response (FIR) filter. It should be noted that, filtering processing is to obtain energy of high-frequency signals in the teaching audio. That is, energy of low-frequency signals is suppressed while the high-frequency signals of the teaching audio are allowed to pass through design of the high-pass filter, and a foreground sound and a background sound may be further distinguished according to high-frequency energy changes.

At step S706, a plurality of speech frames within a first preset duration are extracted from the processing result. In some embodiments, the first preset duration is a preset time period, for example, 3 seconds, which is not limited herein. In practice, the first preset duration can be set and changed according to an actual requirement of a user. In some embodiments, a plurality of speech frames within the first preset duration can be extracted from the processing result in a VAD manner.

At step S708, an energy variation amount of the plurality of speech frames is obtained. In some embodiments, the energy variation amount of the plurality of speech frames includes an energy mean value and an energy variance value of a plurality of energy values.

At step S710, whether the teaching audio is a voice of a host of the online class is determined based on the energy variation amount. In some embodiments, the category of the teaching audio includes: a foreground sound and a background sound. An example in which the audio processing method provided in the embodiments of the present disclosure is applicable to a remote video teaching scenario is used. In this example, based on high-frequency performance of a foreground sound (for example, a voice of a host) and a background sound on the acquisition end of the speech communication device, the foreground sound and the background sound in the teaching audio are automatically distinguished. That is, according to the propagation principle of speech signals, high-frequency signals are close to linear propagation and can hardly bypass an obstacle, so that characteristics of high-frequency signals passing through the high-pass filter can be used for determining whether an acquired speech signal is a background sound.

In some embodiments, audio processing method 700 provided in the present disclosure can be applicable to, but not limited to, a remote teaching application scenario, for example, an audio/video real-time communication project (for example, an audio/video delivery class). By applying the audio processing method provided in the embodiments of the present disclosure, teaching audio acquired by microphone devices of different audio/video devices may be automatically processed in the remote teaching application scenario.

According to the embodiments of the present disclosure, even in a case that a foreground sound (that is, a voice of a host of an online class) is quite small or in a case without the foreground sound, after a processing result is obtained by performing filtering processing on teaching audio acquired by an audio acquisition end, a plurality of speech frames within a first preset duration are extracted from the processing result, an energy variation amount of the plurality of speech frames are obtained, and a category of the teaching audio may be further determined based on the energy variation amount. That is, whether the teaching audio is a foreground sound or a background sound can be distinguished. Therefore, in a remote audio/video scenario, a remote user may not hear a louder background sound, so that the user experience may not be affected.

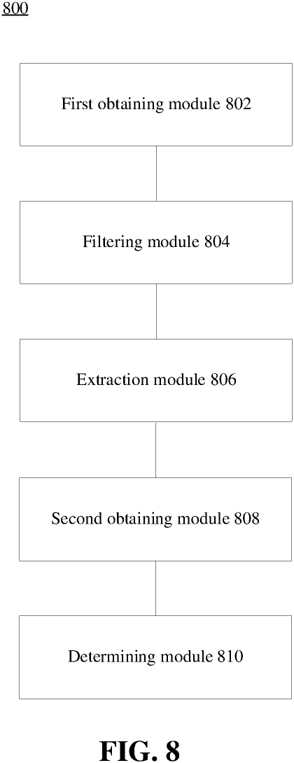

According to some embodiments of the present disclosure, an apparatus used for performing the audio processing method is further provided. FIG. 8 is a schematic structural diagram of an audio processing device 800 according to an embodiment of the present disclosure. As shown in FIG. 8, the audio processing device 800 includes a first obtaining module 802, a filtering module 804, an extraction module 806, a second obtaining module 808, and a determining module 810. It can be understood that, the one or more modules can be realized as a circuit, a filter, an extractor, a controller, or a processor, etc.

The first obtaining module 802 (e.g., a processor) is configured to obtain to-be-processed audio acquired by an audio acquisition end. The filtering module 804 (e.g., a filter) is configured to perform filtering processing on the to-be-processed audio to obtain a processing result, where the filtering processing is used for filtering out some audio signal components from the to-be-processed audio, and frequencies of the audio signal components are lower than a preset threshold. The extraction module 806 (e.g., an extractor) is configured to extract a plurality of speech frames within a first preset duration from the processing result. The second obtaining module 808 (e.g., a processor) is configured to obtain an energy variation amount of the plurality of speech frames. The determining module 810 (e.g., a processor) is configured to determine a category of the to-be-processed audio based on the energy variation amount.

It is noted that, according to the embodiments of the present disclosure, even in a case that a foreground sound is quite small or in a case without the foreground sound, after a processing result is obtained by performing high-pass filtering processing on to-be-processed audio acquired by an audio acquisition end, a plurality of speech frames within a first preset duration are extracted from the processing result, an energy variation amount of the plurality of speech frames are obtained, and a category of the to-be-processed audio may be further determined based on the energy variation amount. That is, whether the to-be-processed audio is a foreground sound or a background sound can be distinguished. Therefore, in a remote audio/video scenario, a remote user may not hear a louder background sound, so that the user experience is improved.

Therefore, the objective of quickly and accurately distinguishing between a foreground sound and a background sound is achieved in the embodiments of the present disclosure, thereby achieving technical effects of improving the audio distinguishing efficiency and improving the user experience, and further resolving the technical problems of low audio distinguishing efficiency and poor user experience caused by that the audio system cannot distinguish between a foreground sound and a background sound in the related art.

It should be noted herein that, the first obtaining module 802, the filtering module 804, the extraction module 806, the second obtaining module 808, and the determining module 810 can correspond to step S202 to step S210. An implementation instance and an application scenario of the modules are the same as those of the corresponding steps, but are not limited to the content disclosed above. It should be noted that, the foregoing modules can be run on the computer terminal 100 of FIG. 1 as a part of the apparatus.

According to some embodiments of the present disclosure, an electronic device is further provided, and the electronic device may be any computing device in a computing device cluster. The electronic device includes a processor and a memory. The memory is connected to the processor, configured to provide the processor with instructions for processing the following processing steps: obtaining to-be-processed audio acquired by an audio acquisition end; performing filtering processing on the to-be-processed audio to obtain a processing result, where the filtering processing is used for filtering out some audio signal components from the to-be-processed audio, and frequencies of the audio signal components are lower than a preset threshold; extracting a plurality of speech frames within a first preset duration from the processing result; obtaining an energy variation amount of the plurality of speech frames; and determining a category of the to-be-processed audio based on the energy variation amount.

It is noted that, according to the embodiments of the present disclosure, even in a case that a foreground sound is quite small or in a case without the foreground sound, after a processing result is obtained by performing high-pass filtering processing on to-be-processed audio acquired by an audio acquisition end, a plurality of speech frames within a first preset duration are extracted from the processing result, an energy variation amount of the plurality of speech frames are obtained, and a category of the to-be-processed audio may be further determined based on the energy variation amount. That is, whether the to-be-processed audio is a foreground sound or a background sound can be distinguished. Therefore, in a remote audio/video scenario, a remote user may not hear a louder background sound, so that the user experience can be improved.

Therefore, the objective of quickly and accurately distinguishing between a foreground sound and a background sound is achieved, thereby achieving technical effects of improving the audio distinguishing efficiency and improving the user experience, and further resolving the technical problems of low audio distinguishing efficiency and poor user experience caused by that the audio system cannot distinguish between a foreground sound and a background sound in the related art.

According to some embodiments of the present disclosure, a computer terminal is further provided. The computer terminal may be any computer terminal device in a computer terminal cluster. In some embodiments, the computer terminal may also be replaced with a terminal device such as a mobile terminal.

In some embodiments, the computer terminal may be located in at least one of a plurality of network devices in a computer network.

In some embodiments, the computer terminal may execute program instructions of application program for the following steps in the audio processing method: obtaining to-be-processed audio acquired by an audio acquisition end; performing filtering processing on the to-be-processed audio to obtain a processing result, where the filtering processing is used for filtering out some audio signal components from the to-be-processed audio, and frequencies of the audio signal components are lower than a preset threshold; extracting a plurality of speech frames within a first preset duration from the processing result; obtaining an energy variation amount of the plurality of speech frames; and determining a category of the to-be-processed audio based on the energy variation amount.

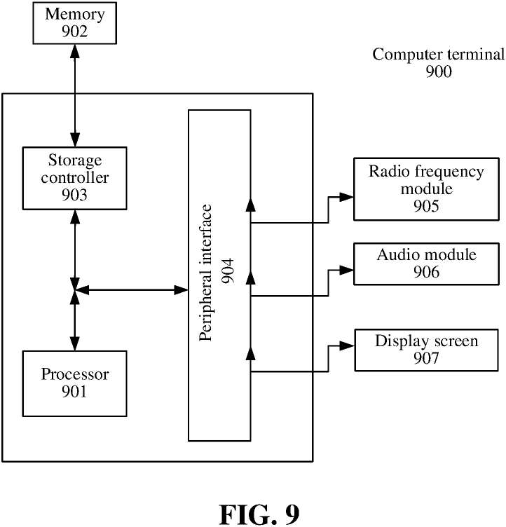

FIG. 9 is a structural block diagram of another computer terminal according to some embodiments of the present disclosure. As shown in FIG. 9, the computer terminal 900 may include one or more processors 901 (only one processor is shown in the figure), a memory 902, and a peripheral interface 904.

Memory 902 may be configured to store a software program and a module, for example, a program instruction/module corresponding to the audio processing method and device in the embodiments of the present disclosure. The processor executes the software program and the module stored in memory 902, to implement various functional applications and data processing, that is, implement the foregoing audio processing method. Memory 902 may include a high-speed random memory, and may also include a non-volatile memory, for example, one or more magnetic storage apparatuses, flash memories, or other non-volatile solid-state memories. In some examples, memory 902 may further include memories remotely arranged relative to the processor, and these remote memories may be connected to computer terminal 900 through a network. Examples of the network include, but are not limited to, the Internet, an intranet, a local area network, a mobile communication network, and a combination thereof.

Processor 901 may invoke, by using a transmission apparatus, the information and the application program that are stored in the memory, to perform the following steps: obtaining to-be-processed audio acquired by an audio acquisition end; performing filtering processing on the to-be-processed audio to obtain a processing result, where the filtering processing is used for filtering out some audio signal components from the to-be-processed audio, and frequencies of the audio signal components are lower than a preset threshold; extracting a plurality of speech frames within a first preset duration from the processing result; obtaining an energy variation amount of the plurality of speech frames; and determining a category of the to-be-processed audio based on the energy variation amount.

In some embodiments, processor 901 may also execute program instructions to perform the following steps: performing high-pass filtering processing on the to-be-processed audio through an FIR filter to obtain the processing result, where a filter order of the FIR filter is a positive integer greater than or equal to 1.

In some embodiments, processor 901 may also execute program instructions to perform the following steps: obtaining a second preset duration, where the second preset duration is a unit duration corresponding to each speech frame in the plurality of speech frames; and extracting the plurality of speech frames from the processing result in a VAD manner based on the first preset duration and the second preset duration.

In some embodiments, processor 901 may also execute program instructions to perform the following steps: obtaining an energy value corresponding to each speech frame in the plurality of speech frames, to obtain a plurality of energy values; and calculating an energy mean value and an energy variance value of the plurality of energy values.

In some embodiments, processor 901 may also execute program instructions to perform the following steps: determining the category of the to-be-processed audio based on a comparison result between the energy mean value and a first threshold and a comparison result between the energy variance value and a second threshold.

In some embodiments, processor 901 may also execute program instructions to perform the following steps: determining the to-be-processed audio as a background sound in a case that the energy mean value is less than the first threshold and the energy variance value is less than the second threshold.

In some embodiments, processor 901 may also execute program instructions to perform the following steps: determining the to-be-processed audio as a foreground sound in a case that the energy mean value is greater than or equal to the first threshold and the energy variance value is greater than or equal to the second threshold.

Processor 901 may invoke, by using the transmission apparatus, the information and the application program that are stored in the memory, to perform the following steps: acquiring conference audio of an online conference through an audio acquisition end; performing filtering processing on the conference audio to obtain a processing result, where the filtering processing is used for filtering out some audio signal components from the conference audio, and frequencies of the audio signal components are lower than a preset threshold; extracting a plurality of speech frames within a first preset duration from the processing result; obtaining an energy variation amount of the plurality of speech frames; and determining whether the conference audio is a voice of a host of the online conference based on the energy variation amount.

Processor 901 may invoke, by using the transmission apparatus, the information and the application program that are stored in the memory, to perform the following steps: acquiring teaching audio of an online class through an audio acquisition end; performing filtering processing on the teaching audio to obtain a processing result, where the filtering processing is used for filtering out some audio signal components from the teaching audio, and frequencies of the audio signal components are lower than a preset threshold; extracting a plurality of speech frames within a first preset duration from the processing result; obtaining an energy variation amount of the plurality of speech frames; and determining whether the teaching audio is a voice of a host of the online class based on the energy variation amount.

According to the embodiments of the present disclosure, an audio processing solution is provided. The audio processing solution includes: obtaining to-be-processed audio acquired by an audio acquisition end; performing filtering processing on the to-be-processed audio to obtain a processing result, where the filtering processing is used for filtering out some audio signal components from the to-be-processed audio, and frequencies of the audio signal components are lower than a preset threshold; extracting a plurality of speech frames within a first preset duration from the processing result; obtaining an energy variation amount of the plurality of speech frames; and determining a category of the to-be-processed audio based on the energy variation amount.

It is noted that, according to the embodiments of the present disclosure, even in a case that a foreground sound is quite small or in a case without the foreground sound, after a processing result is obtained by performing high-pass filtering processing on to-be-processed audio acquired by an audio acquisition end, a plurality of speech frames within a first preset duration are extracted from the processing result, an energy variation amount of the plurality of speech frames are obtained, and a category of the to-be-processed audio may be further determined based on the energy variation amount. That is, whether the to-be-processed audio is a foreground sound or a background sound can be distinguished. Therefore, in a remote audio/video scenario, a remote user may not hear a louder background sound, so that the user experience may not be affected.

Therefore, the objective of quickly and accurately distinguishing between a foreground sound and a background sound is achieved in the embodiments of the present disclosure, thereby achieving technical effects of improving the audio distinguishing efficiency and improving the user experience, and further resolving the technical problems of low audio distinguishing efficiency and poor user experience caused by that the audio system cannot distinguish between a foreground sound and a background sound.

A person of ordinary skill in the art may understand that the structure shown in FIG. 9 is merely an example, and the computer terminal may also be a terminal device such as a smartphone (for example, an Android mobile phone or an iOS mobile phone), a tablet computer, a palmtop computer, a mobile Internet device (MID), and a PAD. Computer terminal 900 may include one or more peripheral devices coupled to peripheral interface 904. For example, the one or more peripheral devices includes a radio frequency module 905 (e.g., an antenna), an audio module 906 (e.g., a speaker), and/or a display screen 907. FIG. 9 does not constitute a limitation to the structure of the electronic device. For example, the computer terminal 900 may further include more or fewer components (for example, a storage controller 903, a network interface etc.) than those shown in FIG. 9, or have a configuration different from that shown in FIG. 9.

A person of ordinary skill in the art may understand that all or some of the steps of the methods in the foregoing embodiments may be implemented by a program instructing relevant hardware of the terminal device. The program may be stored in a computer-readable storage medium. The storage medium may include a flash drive, a read-only memory (ROM), a random access memory (RAM), a magnetic disk, or an optical disc.

According to the embodiments of the present disclosure, an embodiment of a computer-readable storage medium is further provided. In some embodiments, the storage medium may be configured to store program instructions executed in the audio processing method provided above.

In some embodiments, the storage medium may be located in any computer terminal in a computer terminal cluster in a computer network, or in any mobile terminal in a mobile terminal cluster.

In some embodiments, the storage medium is configured to store program instructions used to perform the following steps: obtaining to-be-processed audio acquired by an audio acquisition end; performing filtering processing on the to-be-processed audio to obtain a processing result, where the filtering processing is used for filtering out some audio signal components from the to-be-processed audio, and frequencies of the audio signal components are lower than a preset threshold; extracting a plurality of speech frames within a first preset duration from the processing result; obtaining an energy variation amount of the plurality of speech frames; and determining a category of the to-be-processed audio based on the energy variation amount.

In some embodiments, the storage medium is configured to store program instructions for performing the following steps: performing high-pass filtering processing on the to-be-processed audio through an FIR filter to obtain the processing result, where a filter order of the FIR filter is a positive integer greater than or equal to 1.

In some embodiments, the storage medium is configured to store program instructions for performing the following steps: obtaining a second preset duration, where the second preset duration is a unit duration corresponding to each speech frame in the plurality of speech frames; and extracting the plurality of speech frames from the processing result in a VAD manner based on the first preset duration and the second preset duration.

In some embodiments, the storage medium is configured to store program instructions for performing the following steps: obtaining an energy value corresponding to each speech frame in the plurality of speech frames, to obtain a plurality of energy values; and calculating an energy mean value and an energy variance value of the plurality of energy values.

In some embodiments, the storage medium is configured to store program instructions for performing the following steps: determining the category of the to-be-processed audio based on a comparison result between the energy mean value and a first threshold and a comparison result between the energy variance value and a second threshold.

In some embodiments, the storage medium is configured to store program instructions for performing the following steps: determining the to-be-processed audio as a background sound in a case that the energy mean value is less than the first threshold and the energy variance value is less than the second threshold.

In some embodiments, the processor may also execute program instruction to perform the following steps: determining the to-be-processed audio as a foreground sound in a case that the energy mean value is greater than or equal to the first threshold and the energy variance value is greater than or equal to the second threshold.

In some embodiments, the processor may also execute program instruction to perform the following steps: acquiring conference audio of an online conference through an audio acquisition end; performing filtering processing on the conference audio to obtain a processing result, where the filtering processing is used for filtering out some audio signal components from the conference audio, and frequencies of the audio signal components are lower than a preset threshold; extracting a plurality of speech frames within a first preset duration from the processing result; obtaining an energy variation amount of the plurality of speech frames; and determining whether the conference audio is a voice of a host of the online conference based on the energy variation amount.

In some embodiments, the processor may also execute program instruction to perform the following steps: acquiring teaching audio of an online class through an audio acquisition end; performing filtering processing on the teaching audio to obtain a processing result, where the filtering processing is used for filtering out some audio signal components from the teaching audio, and frequencies of the audio signal components are lower than a preset threshold; extracting a plurality of speech frames within a first preset duration from the processing result; obtaining an energy variation amount of the plurality of speech frames; and determining whether the teaching audio is a voice of a host of the online class based on the energy variation amount.

The flow charts and block diagrams in the accompanying drawings illustrate architectures, functions, and operations of the possible implementations of the systems, methods, and computer program products according to various implementations of the present disclosure. In this regard, each block in the route diagram or block diagram may represent a module, program segment, or part of code, which includes one or more executable instructions for implementing the specified logic functions. It should also be noted that, in some alternative implementations, the functions marked in the blocks may also occur in a different order from that marked in the drawings. For example, two blocks shown in succession may actually be executed substantially in parallel, and they may sometimes also be executed in the reverse order, depending on the functions involved. It should also be noted that each block in the block diagrams and/or flow charts, and the combination of the blocks in the block diagrams and/or flow charts, may be implemented by a dedicated hardware-based system that performs specified functions or operations, or by a combination of dedicated hardware and computer instructions.

The units or modules described in the embodiments of the present disclosure may be implemented by software or hardware. The described units or modules may also be provided in the processor, and the names of these units or modules do not in any way constitute a limitation on the units or modules themselves.

As another aspect, the embodiments of the present disclosure also provide a computer-readable storage medium. The computer-readable storage medium may be a computer-readable storage medium included in the apparatus described in the above implementations; or may exist alone without being assembled in the device. The computer-readable storage medium stores one or more programs, and the programs are used by one or more processors to perform the methods described in the embodiments of the present disclosure.

The above description is only a preferred embodiment of the present disclosure and an explanation of the applied technical principles. Those skilled in the art should understand that the scope of the disclosure involved in the embodiments of the present disclosure is not limited to the technical solutions formed by specific combinations of the above technical features, but should also cover other technical solutions formed by any combination of the above technical features or equivalent features thereof without departing from the inventive concept. For example, the above features and the technical features disclosed in (but not limited to) the embodiments of the present disclosure having similar functions are replaced with each other to form a technical solution.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. An audio processing method, comprising:
obtaining to-be-processed audio acquired by an audio acquisition end;
performing filtering processing on the to-be-processed audio to obtain a processing result, wherein the filtering processing is used for filtering out partial audio signal components from the to-be-processed audio and frequencies of the partial audio signal components that are lower than a preset threshold;
extracting a plurality of speech frames within a first preset duration from the processing result;
obtaining an energy variation amount of the plurality of speech frames; and
determining a category of the to-be-processed audio based on the energy variation amount.

2. The audio processing method according to claim 1, wherein performing filtering processing on the to-be-processed audio to obtain the processing result comprises:
performing high-pass filtering processing on the to-be-processed audio through a finite impulse response (FIR) filter to obtain the processing result, wherein a filter order of the FIR filter is a positive integer greater than or equal to 1.

3. The audio processing method according to claim 1, wherein extracting the plurality of speech frames within the first preset duration from the processing result comprises:
obtaining a second preset duration, wherein the second preset duration is a unit duration corresponding to each speech frame in the plurality of speech frames; and
extracting the plurality of speech frames from the processing result in a voice activity detection (VAD) manner based on the first preset duration and the second preset duration.

4. The audio processing method according to claim 1, wherein obtaining the energy variation amount of the plurality of speech frames comprises:
obtaining a plurality of energy values by obtaining an energy value corresponding to each speech frame in the plurality of speech frames; and
calculating an energy mean value and an energy variance value of the plurality of energy values.

5. The audio processing method according to claim 4, wherein determining the category of the to-be-processed audio based on the energy variation amount comprises:
determining the category of the to-be-processed audio based on a comparison result between the energy mean value and a first threshold and a comparison result between the energy variance value and a second threshold.

6. The audio processing method according to claim 5, wherein determining the category of the to-be-processed audio based on the comparison result between the energy mean value and the first threshold and the comparison result between the energy variance value and the second threshold comprises:
determining the to-be-processed audio as a background sound when the energy mean value is less than the first threshold and the energy variance value is less than the second threshold.

7. The audio processing method according to claim 5, wherein determining the category of the to-be-processed audio based on the comparison result between the energy mean value and the first threshold and the comparison result between the energy variance value and the second threshold comprises:
determining the to-be-processed audio as a foreground sound when the energy mean value is greater than or equal to the first threshold and the energy variance value is greater than or equal to the second threshold.

8. The audio processing method according to claim 1, wherein the to-be-processed audio acquired by the audio acquisition end is conference audio of an online conference, and determining the category of the to-be-processed audio based on the energy variation amount further comprises:
determining whether the conference audio is a voice of a host of the online conference based on the energy variation amount.

9. The audio processing method according to claim 1, wherein the to-be-processed audio acquired by the audio acquisition end is teaching audio of an online class, and determining the category of the to-be-processed audio based on the energy variation amount further comprises:
determining whether the teaching audio is a voice of a host of the online class based on the energy variation amount.

10. An apparatus for performing audio processing, the apparatus comprising:
a memory figured to store instructions; and
one or more processors configured to execute the instructions to cause the apparatus to perform:
obtaining to-be-processed audio acquired by an audio acquisition end;
performing filtering processing on the to-be-processed audio to obtain a processing result, wherein the filtering processing is used for filtering out partial audio signal components from the to-be-processed audio, and frequencies of the partial audio signal components that are lower than a preset threshold;
extracting a plurality of speech frames within a first preset duration from the processing result;
obtaining an energy variation amount of the plurality of speech frames; and
determining a category of the to-be-processed audio based on the energy variation amount.

11. The apparatus according to claim 10, wherein the one or more processors are further configured to execute the instructions to cause the apparatus to perform:
performing high-pass filtering processing on the to-be-processed audio through a finite impulse response (FIR) filter to obtain the processing result, wherein a filter order of the FIR filter is a positive integer greater than or equal to 1.

12. The apparatus according to claim 10, wherein the one or more processors are further configured to execute the instructions to cause the apparatus to perform:
obtaining a second preset duration, wherein the second preset duration is a unit duration corresponding to each speech frame in the plurality of speech frames; and
extracting the plurality of speech frames from the processing result in a voice activity detection (VAD) manner based on the first preset duration and the second preset duration.

13. The apparatus according to claim 10, wherein the one or more processors are further configured to execute the instructions to cause the apparatus to perform:
obtaining a plurality of energy values by obtaining an energy value corresponding to each speech frame in the plurality of speech frames; and
calculating an energy mean value and an energy variance value of the plurality of energy values.

14. The apparatus according to claim 10, wherein the to-be-processed audio acquired by the audio acquisition end is conference audio of an online conference, and the one or more processors are further configured to execute the instructions to cause the apparatus to perform:
determining whether the conference audio is a voice of a host of the online conference based on the energy variation amount.

15. The apparatus according to claim 10, wherein the to-be-processed audio acquired by the audio acquisition end is teaching audio of an online class, and the one or more processors are further configured to execute the instructions to cause the apparatus to perform:
determining whether the teaching audio is a voice of a host of the online class based on the energy variation amount.

16. A non-transitory computer readable medium that stores a set of instructions that is executable by one or more processors of an apparatus to cause the apparatus to perform:
obtaining to-be-processed audio acquired by an audio acquisition end;
performing filtering processing on the to-be-processed audio to obtain a processing result, wherein the filtering processing is used for filtering out partial audio signal components from the to-be-processed audio, and frequencies of the partial audio signal components that are lower than a preset threshold;
extracting a plurality of speech frames within a first preset duration from the processing result;
obtaining an energy variation amount of the plurality of speech frames; and
determining a category of the to-be-processed audio based on the energy variation amount.

17. The non-transitory computer readable medium according to claim 16, wherein the set of instructions that is executable by the one or more processors of the apparatus to cause the apparatus to further perform:
performing high-pass filtering processing on the to-be-processed audio through a finite impulse response (FIR) filter to obtain the processing result, wherein a filter order of the FIR filter is a positive integer greater than or equal to 1.

18. The non-transitory computer readable medium according to claim 16, wherein the set of instructions that is executable by the one or more processors of the apparatus to cause the apparatus to further perform:
obtaining a second preset duration, wherein the second preset duration is a unit duration corresponding to each speech frame in the plurality of speech frames; and
extracting the plurality of speech frames from the processing result in a voice activity detection (VAD) manner based on the first preset duration and the second preset duration.

19. The non-transitory computer readable medium according to claim 16, wherein the to-be-processed audio acquired by the audio acquisition end is conference audio of an online conference, and the set of instructions that is executable by the one or more processors of the apparatus to cause the apparatus to further perform:
determining whether the conference audio is a voice of a host of the online conference based on the energy variation amount.

20. The non-transitory computer readable medium according to claim 16, wherein the to-be-processed audio acquired by the audio acquisition end is teaching audio of an online class, and the set of instructions that is executable by the one or more processors of the apparatus to cause the apparatus to further perform:
determining whether the teaching audio is a voice of a host of the online class based on the energy variation amount.
